(19) United States
(12) Patent Application Publication
(10) Pub. No.: US 2023/0342297 A1
(43) Pub. Date: Oct. 26, 2023

(54) MULTISYSTEM SHARED MEMORY

(71) Applicant: Intel Corporation, Santa Clara, CA (US)

(72) Inventor: Timothy WITHAM, Aloha, OR (US)

(21) Appl. No.: 18/215,535

(22) Filed: Jun. 28, 2023

(51) Int. Cl. G06F 12/0815

(52) U.S. Cl. CPC G06F 12/0815

(57) ABSTRACT

A system includes multiple devices with a shared memory. The devices interconnect to each other via an optical communication link, with broadcast sends as producers, and receiving messages from others as consumers of the other devices. The devices receive a packet from a producer that has a lock on a cache line of the shared memory. In response to the packet, the devices send an acknowledgement or negative acknowledgement, and invalidate the cache line that is the subject of the message in a local copy of the shared memory. The devices can update the cache line in the local copy of the shared memory as data is processed as received over the optical communication link.

### TECHNICAL FIELD

Descriptions are generally related to memory, and more particular descriptions are related to a shared memory architecture.

### BACKGROUND OF THE INVENTION

Some computer systems include multiple processor nodes that share processing tasks. The shared processing tasks computed by the processing nodes can use a shared memory. With a shared memory, the separate nodes have local copies of data structures used in the processing tasks. The scaling of shared memory to a larger number of processing units can consume significant amounts of network bandwidth. Additionally, adding more nodes tends to increase the delays associated with sharing data and dealing with coherency.

One implementation of a shared memory uses a central node to manage the coherency and pass data updates to the nodes. The use of the central node can add significant delays as the number of nodes sharing the memory increases. One way to handle the delays is to use a non-uniform memory architecture (NUMA) design, which includes a large, shared memory bus. The increased bus size significantly increases the system cost. Additionally, the NUMA designs tend to require custom processor (e.g., central processing unit (CPU)) cards, seeing that commodity CPU cards do not have the hardware necessary to accommodate the custom memory buses. Additionally, NUMA systems tend to have complex memory coherency algorithms, which results in slower overall memory semantics. Furthermore, some NUMA systems employ large, expensive caches to attempt to reduce the performance impact of the memory coherency issues and the sharing among many nodes.

### BRIEF DESCRIPTION OF THE DRAWINGS

The following description includes discussion of figures having illustrations given by way of example of an implementation. The drawings should be understood by way of example, and not by way of limitation. As used herein, references to one or more examples are to be understood as describing a particular feature, structure, or characteristic included in at least one implementation of the invention. Phrases such as “in one example” or “in an alternative example” appearing herein provide examples of implementations of the invention, and do not necessarily all refer to the same implementation. However, they are also not necessarily mutually exclusive.

FIG. 1 is a block diagram of an example of a computer system with a shared memory architecture.

FIG. 2 is a block diagram of an example of a node of a computer system with a shared memory architecture.

FIGS. 3A-3D are block diagrams of an example of a shared memory system response to a cache line lock.

FIGS. 4A-4C are block diagrams of an example of a shared memory system response to a multi-cache line lock.

FIG. 5 is a block diagram of an example of a computer device of a shared memory architecture.

FIG. 6A-6B are diagrams of an example of an optical link for a shared memory system.

FIG. 6C is a block diagram of an example of an optical broadcast.

FIG. 6D is a block diagram of another example of an optical broadcast.

FIG. 7 is a block diagram of an example of a shared memory frontend interface.

FIG. 8 is a table representation of additive bandwidth.

FIG. 9 is a flow diagram of an example of a process for a shared memory system.

FIG. 10 is a block diagram of an example of a computing system in which a shared memory interface can be implemented.

FIG. 11 is a block diagram of an example of a multi-node network in which a shared memory system can be implemented.

Descriptions of certain details and implementations follow, including non-limiting descriptions of the figures, which may depict some or all examples, and well as other potential implementations.

### DETAILED DESCRIPTION OF THE INVENTION

As described herein, a system includes a system having multiple devices with a shared memory architecture. The shared memory architecture includes an optical communication link to interconnect the multiple devices, with the optical communication link available for memory transfers. The optical link can replace a large, shared memory bus implemented with electrical connections.

The multiple devices in the system generate broadcast sends as producers when they make updates to the data in the shared memory. The multiple devices are also consumers of the other devices, receiving messages from the other devices when they operate as producers. Thus, each device can be a producer to broadcast memory updates, and the other devices can be consumers to receive the memory updates. The consumer devices receive a packet from a producer device that has a lock on a cache line (sometimes referred to as a “cacheline”) of the shared memory. In response to the received packet, the devices send an acknowledgement (ACK) or negative acknowledgement (NACK), thus sending an ACK/NACK on each message.

The producer will know the update can proceed when all consumers reply with an ACK, and will know to re-attempt the update if it receives a NACK from one of the consumers. In response to a successful message receive (e.g., associated with sending an ACK), the consumers invalidate the cache line that is the subject of the message in a local copy of the shared memory. The devices can update the cache line in the local copy of the shared memory as data is processed as received over the optical communication link.

The use of the optical communication link instead of a large, electrical data bus can enable transfer of data update messages among the various nodes of the system with high speed and high bandwidth. With the optical communication link, it is easier to scale to more system nodes without significant increases in cost. The high speed of the communication link enables low latency transmission. The broadcast transmits/sends can avoid the need for a central coordinating node. The system can scale to 32 nodes, 64 nodes, and even higher numbers of nodes. The model allows for tiered networking, allowing it to be expanded up to 4096 nodes.

The nodes provide an ACK/NACK for each message, which enables the system to provide inherent cache coherency without complex algorithms. Rather, each node can perform a data invalidation in association with each ACK sent. In one example, the invalidation of the data stalls the execution at the receiving node. However, data transfer over an optical communication link is very high speed. Coupled with direct memory access from the optical communication link, the total delay for each node is comparable to an internal memory transaction, as opposed to taking multiple memory write cycles simply to transmit the message.

If a memory write transaction is approximately 15.5 nanoseconds (nsec), the system can provide published node data receive jitter of less than 14 nsec across all endpoints/nodes in the system. Thus, the jitter is less than one memory cycle time. It will be understood that tiered architectures may incur increased latency to traverse the different tiers, but can allow significantly larger systems with timings that are orders of magnitude lower than known electrical interconnected shared memory systems.

An example system with the described optical communication link (also referred to as an optical interface) can use a single send light pipe for publish with a receive light pipe for each consumer. In one example, the system is organized in groups of nodes, where nodes that share memory can register as a consumer for (and thus a publisher to) other, selected nodes. The registered nodes can share messages for shared memory portions, enabling portioning of the system into selected shared memory portions for different processing operations.

The optical interface enables a single send to all nodes (e.g., all subscriber/registered nodes) simultaneously, combined with integration with the single node shared memory parallelism (SMP) programming model to provide remote cache line invalidation. Such a system enables communication cache line to cache line in less time than a system memory cycle. Consider a system with multiple central processing unit (CPU) nodes. The nodes can each be a blade server or a processor on a blade server (e.g., for blade servers having multiple CPUs). Such an implementation with memory and CPU infrastructure for up to 64 systems can be viewed as a single system without delaying the operation of the single node. The interconnection of devices results in near simultaneous data synchronization across 64 nodes, allowing for a single programming image across all the nodes with a familiar programming model (e.g., SMP). In one example, with remote cache line invalidation, the receivers can start to process a message as soon as the initial cache line is received.

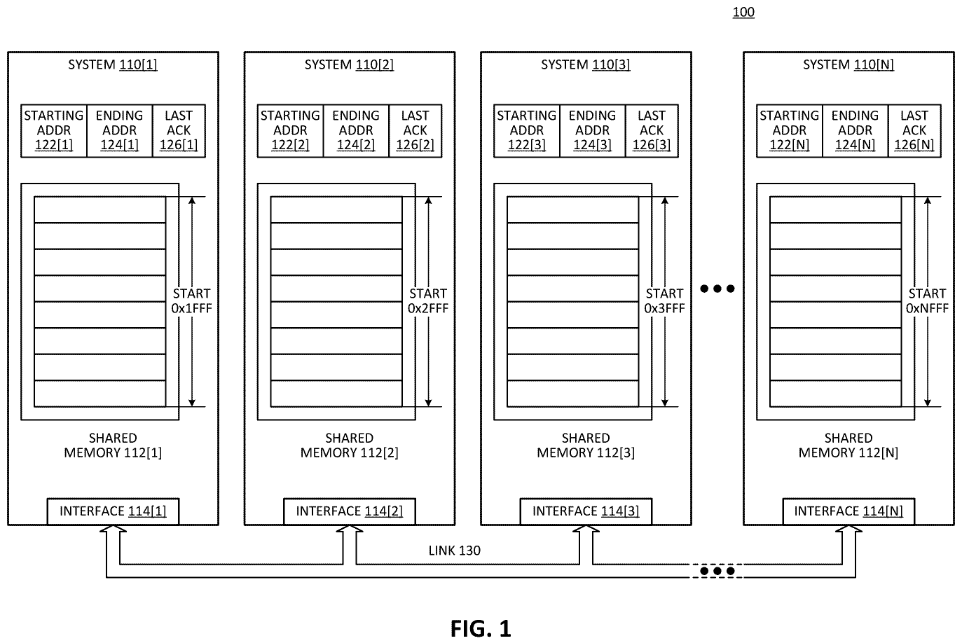

FIG. 1 is a block diagram of an example of a computer system with a shared memory architecture. System 100 illustrates an example of a system in accordance with what is described above. System 100 is illustrated with N systems, system 110[1], system 110[2], system 110[3], . . . , system 110[N], collectively systems 110. Each system 110 can represent a server device, a processor node, a blade server, or some other node in a system that performs processing operations.

Systems 110 are coupled through link 130. Link 130 represents an optical communication link. In one example, link 130 represents an optical communication link that includes one transmit light pipe and N−1 receive light pipes. Link 130 provides a high-bandwidth, low-latency communication channel.

Systems 110 couple to link 130 through a communication interface, represented as interface 114[1] for system 110[1], interface 114[2] for system 110[2], interface 114[3] for system 110[3], and interface 114[N] for system 110[N]. Collectively, interface 114[1], interface 114[2], interface 114[3], . . . , interface 114[N] can be referred to as interfaces 114. Interfaces 114 can include interconnection hardware to couple to the physical communication link, and can include hardware to process data received over the link.

Each system includes a local copy of a shared memory. For purposes of system 100, the shared memory can be referred to as shared memory 112. System 110[1] includes shared memory 112[1], which is the local copy of the shared memory in system 110[1], having starting address (ADDR) 122[1] and ending address (ADDR) 124[1]. As illustrated, shared memory 112[1] has a start address of 0x1FFF.

Similarly, system 110[2] includes shared memory 112[2], which is the local copy of the shared memory in system 110[2], having starting address 122[2] and ending address 124[2]. As illustrated, shared memory 112[2] has a start address of 0x2FFF. System 110[3] includes shared memory 112[3], which is the local copy of the shared memory in system 110[3], having starting address 122[3] and ending address 124[3]. As illustrated, shared memory 112[3] has a start address of 0x3FFF. System 110[N] includes shared memory 112[N], which is the local copy of the shared memory in system 110[N], having starting address 122[N] and ending address 124[N]. As illustrated, shared memory 112[N] has a start address of 0xNFFF. It will be understood that if N is a number greater than 15 (0xF in hexadecimal), the starting address can have more digits.

In one example, link 130 provides a mechanism to perform a single, simultaneous send to all endpoints, where the endpoints are the other nodes or the other processing systems. Thus, for example, a send from system 110[1] would broadcast to systems 110[2], system 110[3], . . . , system 110[N]. Link 130 can have additive receive bandwidth, where each additional computing system or node of system 100 provides an additional receive channel. As such, the network bandwidth would be limited by the receiver's bandwidth and processing ability, rather than being limited by a central communication node.

The system interconnection can also provide natural fault isolation, as each device has a receive line for each other device. In one example, a system that fails to provide an ACK or a NACK can be ignored by the other systems. If one of the systems stopped responding, the other systems could continue to operate without needing to update the failed system. Additionally, communication as described can prevent head of line blocking as each transmitter goes to the single receiver for each remote node.

System 100 can represent an example of a producer-consumer architecture. In such an architecture, each system 110 operates as a producer to share data updates to other nodes. In one example, each system 110 tracks last acknowledgement (ACK) 126, thus, last ACK 126[1] can identify the last acknowledgement for system 110[1], last ACK 126[2] can identify the last acknowledgement for system 110[2], last ACK 126[3] can identify the last acknowledgement for system 110[3], . . . , and last ACK 126[N] can identify the last acknowledgement for system 110[N].

In one example, systems 110 manage shared memory 112 with SMP memory semantics across the systems without the overhead associated with a management node coordinating the shared memory. In one example, either application of SMP locally at each system 110, or through another memory management mechanism applied at each system 110, shared memory 112 includes simultaneous updates of all nodes. The simultaneous updates can occur through the use of the optical link through interfaces 114 and the processing of data received at the interface.

In one example, the shared memory architecture of system 100 has the following properties: 1) single send to all nodes; 2) all nodes can simultaneously be producers and consumers; 3) any node can be both a producer and a consumer at the same time; 4) additive bandwidth; 5) no head of line blocking; and, 6) ACK/NACK of individual messages. In one example, the system implements a “lazy ACK” procedure. With a lazy ACK, the system does not need to send an ACK for every packet. If the system processes the message correctly, it can process multiple good messages and then provide an ACK for all the good messages. The number of messages per ACK can be configured for the system, such as during system handshake. In one example, the lazy ACK allows the system to wait until all packets are received, where a lack of receiving a NACK can be assumed as an ACK for a packet. If a node sends a NACK, it can be assumed that the prior packets were received correctly, and only the NACKed packet needs to be resent.

The single send to all nodes enables the system to have properties similar to a front side bus for communication between systems 110. The producer node always sends data, and the consumer node always receives data. A node is a producer when it generates an update to data in shared memory 112, such as through locking a cache line. All nodes are receivers when other nodes send data. With the optical links of link 130, each system 110 can transmit at the same time, allowing the producers to simultaneously be consumers. Additive bandwidth refers to the fact that as consumer nodes are added, the system bandwidth increases. It will be understood that link 130 can be expanded to accommodate optical links for each new consumer, interconnecting systems 110. In one example, the data transmission occurs in packets of 64-byte blocks, providing a 64-byte block boundary. Other boundary sizes can be created with different block sizes. In one example, each node provides an ACK/NACK of individual data transmission on the 64-byte block boundary.

Regarding the head of line blocking, consider a scenario where the N systems 110 of system 100 have nodes that communicate with some of the other nodes and not all of them. Consider that Node 1 communicates to all nodes over physical links to node 1 receivers at the other nodes, Node 2 uses node 2 receivers, and so forth. Since Node 2 uses node 2 receivers, Node 1 transmissions will not be blocked by Node 2 transmissions. Similarly, other node transmissions will not be blocked by each other.

In one example, interfaces 114 include, or connect to, hardware to process send and receive data in accordance with a compute express link (CXL). When interfaces 114 are or include CXL interfaces, a 32-node system with 64 Gb/sec x8 CXL interfaces can enable remote nodes to start processing a data message in approximately 53 nanoseconds, regardless of the message size. Additionally, a multi-producer system of 32 nodes can have a receive bandwidth of 1.984 terabits per/second. Increasing that multi-producer system to 64 nodes can provide a receive bandwidth of 4.032 terabits per second.

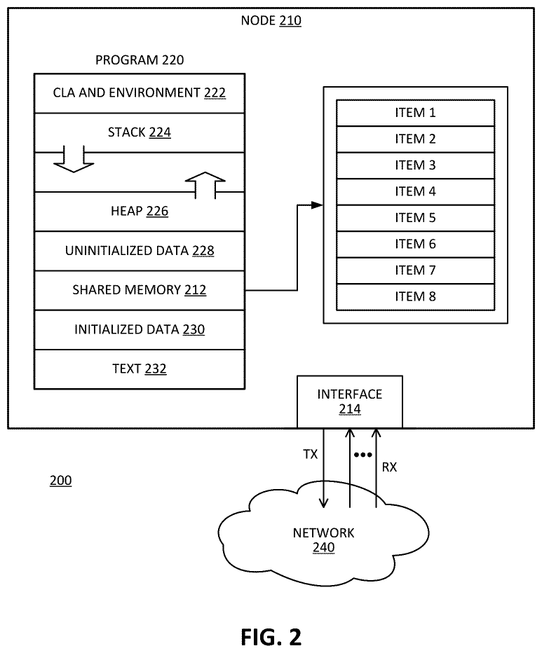

FIG. 2 is a block diagram of an example of a node of a computer system with a shared memory architecture. System 200 is a system in accordance with an example of system 100, where system 200 illustrates a single node of the multidevice system. Node 210 can represent one of systems 110 described above.

Node 210 represents a node in a multidevice system that uses a shared memory. Node 210 includes shared memory 212, which is illustrated having Item 1, Item 2, . . . , Item 8 in the shared memory. The various items can be one or multiple cache lines. Shared memory 212 can store more than the eight items illustrated. Shared memory 212 can be a pre-allocated memory space to map between processes.

Node 210 illustrates the logical portion of the nodes, illustrating program 220. Program 220 represents control of node 210 to execute the functions of the system. It will be understood that program 220 can be executed on a primary processor (e.g., a CPU), a coprocessor, or a combination of the primary processor and an auxiliary processing resource. Program 220 can execute on control law accelerator (CLA) and environment 222. The CLA can refer to a coprocessor that enables parallel processing. CLA from the perspective of program 220 can refer to a CLA task that enables the execution of operations by the CLA coprocessor and other hardware. The environment refers to an operating system or other control flow on which tasks can be executed. The environment can include configuration settings for specific tasks.

In one example, the operating system can be considered part of stack 224. Stack 224 refers to the program components that support execution of program 220. Stack 224 can be organized hierarchically with different architectural layers that provide the control that enables access to data, networks, and hardware resources. Heap 226 can refer to an allocated memory space used by program 220 to initialize different processes. The arrow from stack 224 and from heap 226 to the space between the two blocks can represent the allocation and deallocation of processes to perform operations for program 220.

Shared memory 212 refers to the memory space in which program 220 stores a local copy of data that is shared among multiple nodes. Uninitialized data 228 can represent data allocated in memory for program 220 that is in process before being written to shared memory 212. Initialized data 230 can represent data received from other devices to write into shared memory 212. Text 232 can represent the code of program 220.

Node 210 includes interface 214, which can represent the control for the interface hardware, to connected to network 240. Network 240 represents the interconnection to other nodes in a networked system. As illustrated, in one example, interface 214 includes one transmit (TX) line representing the transmission to other devices, and multiple receive (RX) lines representing the receipt of data from multiple other nodes. Interface 214 can be or include a host bus adapter to interface with the optical communication link over network 240.

In system 200, when node 210 accesses a portion of memory to modify, it sends a command to the other nodes to invalidate their memory. Thus, when program 220 requests a modification to an item of data from shared memory 212, the program locks the data and accesses interface 214 to send a message to the other nodes. Any node other than the one with write access that tries to access the locked portion of the shared memory will stall waiting for the node with write access (e.g., the “write node”) to finish processing. The write node will send an update to the other systems for the shared memory. Such a locking methodology as used on a single node will work on all the nodes that use the shared memory.

Consider an example where node 210 accesses data and its process execution generates a write request to Item 1 of shared memory 212 (e.g., a cache line). Node 210 would send an invalidate to the other nodes over network 240, and in response, they will invalidate Item 1. If the portion to be modified by node 210 is larger than one cache line, it can lock multiple cache lines. In one example, a node can lock up to 64 cache lines and send out a message for an invalidation range of 64 cache lines. In one example, the amount of data in the invalidation range can be megabytes of data. It will be understood that such remote invalidation is also applied in known SMP synchronizing techniques used across multiple processors. As described, the messaging related to the remote invalidation has greater bandwidth and lower latency.

As example process that program 220 and node 210 can apply for updating a block of data can be: 1) acquire the locking structure for the desired data or data range; 2) send a message to the remote subscribers to invalidate the data in all remote memory copies of the shared memory; 3) update the local copy of the block of data; and, 4) send the local block to the remote nodes to enable them to update their local copies. It will be understood that without the use of a central shared memory coordinator, part (2) and part (4) of the process are performed by the write node. All nodes can act as a “central node” in that they control their data, and changes to the data determine which node is a controlling node. Operations related to these parts of the process can be included in system libraries for the locking structure.

In accordance with system 200, the execution of an application in one node can write to another node's application memory. As described herein, the shared memory is cache coherent memory without having or needing external management, referring to a dedicated node that manages the shared memory. In one example, the software model applied by program 220 to manage the shared memory is a simple shared memory system. In one example, the system enables the user to program non-uniform memory architecture (NUMA) applications across multiple nodes without modification to the OS other than a kernel level driver.

The node can be thought of as including hardware components, such as the hardware interface to perform optical broadcast transmission, and the software model, including program 220 and software for interface 214, to the extent other software manages interface 214. In one example, for every packet transmitted, at the barrier of the data packet size, node 210 provides an ACK or a NACK for received messages. The ACK indicates that the message was properly received. The NACK indicates that there was a problem processing the message. A NACK can be intended to trigger the sender to resend the packet.

In one example, the management of interface 214 is based on 64/66 bit encoding. In one example, the interface has a direct memory access (DMA) channel, enabling direct access to shared memory 212 from the interface driver for the optical communication link. The DMA access enables the interface to bypass the program hierarchy and send the data from the message directly to the cache controller.

In one example, the optical communication interface is based on CXL messaging. In one example, interface 214 includes hardware to perform local bus snooping but not remote node snooping. In one example, system 200 has cache line-aligned data or flits. A flit refers to a flow control unit or a digit of the flow control, which is the amount of data transmitted at the link level. System 200 employs remote cache invalidation through the messaging to remote nodes to trigger them to invalidate locked portion(s) of the shared memory.

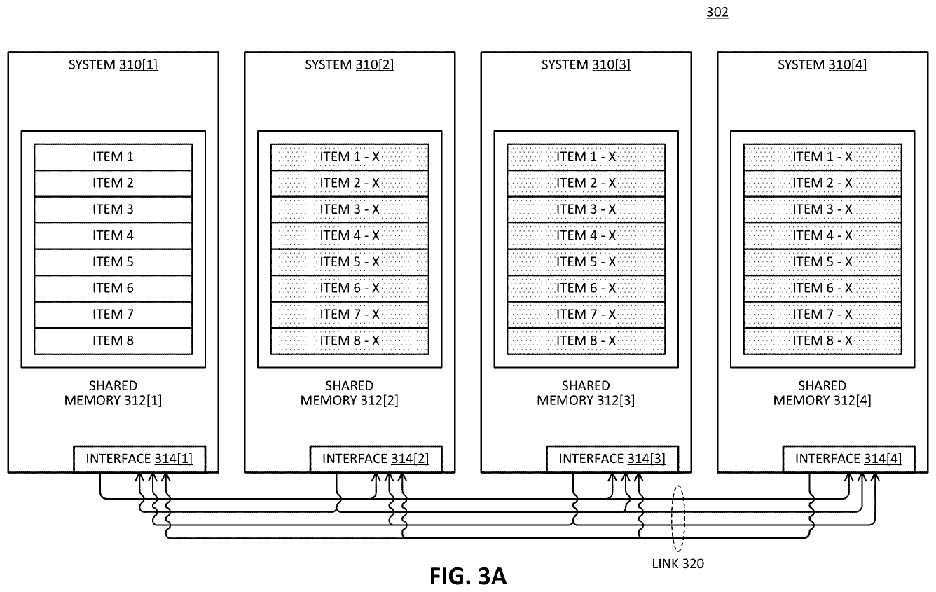

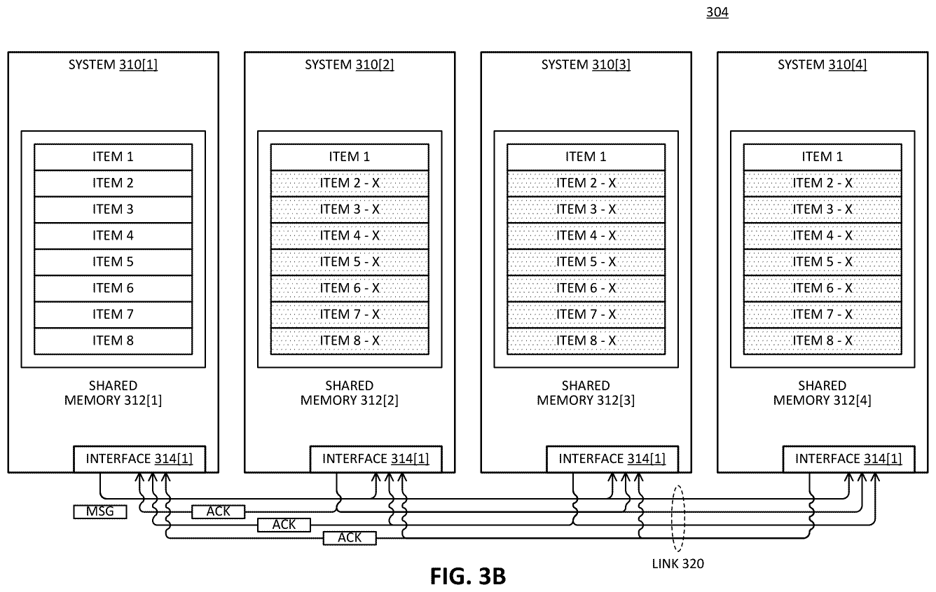

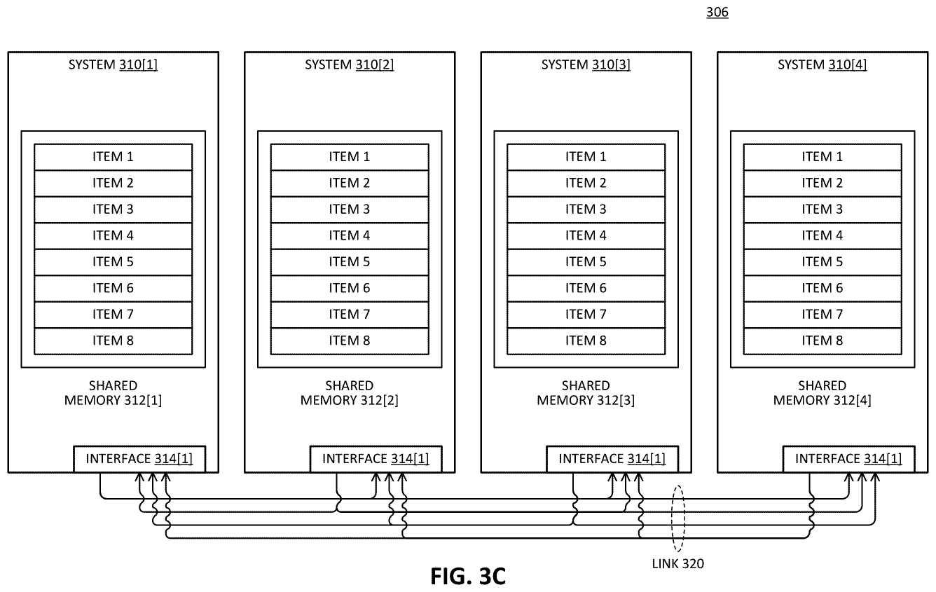

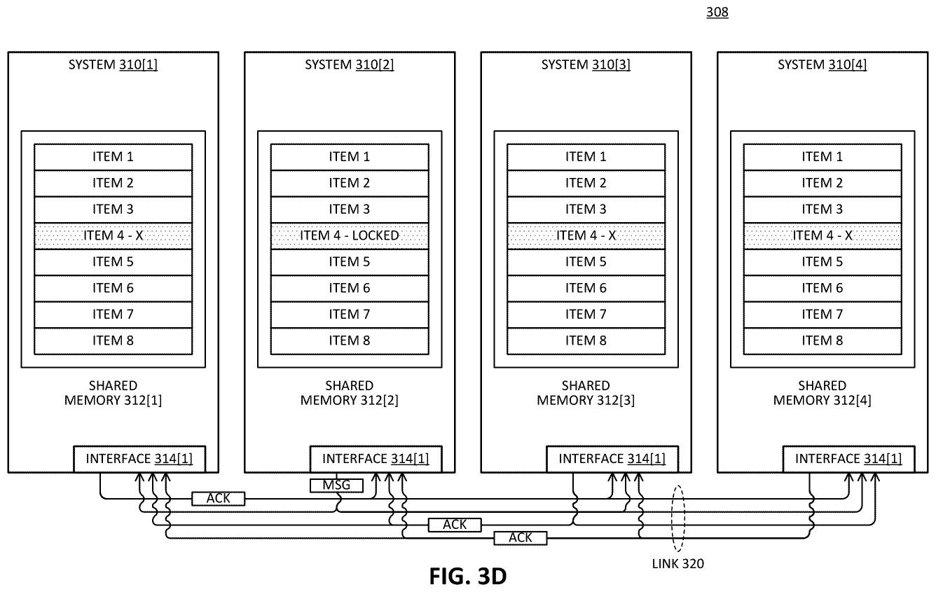

FIGS. 3A-3D are block diagrams of an example of a shared memory system response to a cache line lock. The system of multiple nodes is a shared memory system with multiple computing/processing systems that share a memory space. The multiple nodes sharing a shared memory is a system in accordance with an example of system 100. Systems 310 are nodes in accordance with an example of node 210 of system 200.

The system is illustrated with four nodes, system 310[1], system 310[2], system 310[3], and system 310[4], collectively systems 310. Each system 310 can represent a server device, a processor node, a blade server, or some other node in a system that performs processing operations.

Systems 310 couple to link 320 through a communication interface, represented as interface 314[1] for system 310[1], interface 314[2] for system 310[2], interface 314[3] for system 310[3], and interface 314[4] for system 310[4]. Collectively, interface 314[1], interface 314[2], interface 314[3], . . . , interface 314[N] can be referred to as interfaces 314. Interfaces 314 can include interconnection hardware to couple to the physical communication link, and can include hardware to process data received over the link.

Systems 310 are coupled through link 320. Link 320 represents an optical communication link. As illustrated, link 320 includes a broadcast transmit from each system 310 to each other system 310. Thus, each system 310 includes a single transmit and multiple receive coupled to interfaces 314.

Each system includes a local copy of a shared memory. For purposes of the shared memory system, the shared memory can be referred to as shared memory 312. System 310[1] includes shared memory 312[1], which is the local copy of the shared memory in system 310[1]. System 310[2] includes shared memory 312[2], which is the local copy of the shared memory in system 310[2]. System 310[3] includes shared memory 312[3], which is the local copy of the shared memory in system 310[3]. System 310[4] includes shared memory 312[4], which is the local copy of the shared memory in system 310[4]. Shared memory 312 will have a start address and an end address for the various systems 310, which for simplicity are not specifically illustrated.

The various states indicated below represent a snapshot of the system after a change to memory. At startup, shared memory 312 is clean, and all copies have local copies with memory segments all uninitialized. In one example, there is a primary node, and the other nodes are secondary nodes. Consider that system 310[1] is the primary node.

At startup of the program in system 310[1], the primary node initializes shared memory 312[1]. With handshaking, the program instances start up on system 310[2], system 310[3], and system 310[4]. When the program is started on the other nodes, they invalidate their local copy of the shared memory.

FIG. 3A illustrates state 302, in which system 310[1] populates shared memory 312 with its initial data values. Thus, shared memory 312[1] illustrates Item 1, Item 2, . . . , Item 8 as valid data. Shared memory 312[2], shared memory 312[3], and shared memory 312[4] are all grayed out, with Item 1-X, Item 2-X, . . . , Item 8-X, all representing that these values are invalidated. That invalidation of the data stalls the execution of the program in the secondary nodes. The stalled systems will wait until the data becomes available before resuming execution.

FIG. 3B illustrates state 304, in which system 310[1] sends a message (MSG) on link 320 to the other nodes to indicate the update to shared memory 312[1] and trigger the other nodes to update their local copies of the shared memory. In one example, system 310[1] sends a message to indicate all of the data in shared memory 312[1]. In one example, system 310[1] will send a message for different portions of the memory (e.g., eight messages for all eight items in shared memory 312[1], or four messages addressing two items each message, or some other number of messages). The other nodes send an ACK message back to system 310[1] in response to the message that indicates the data update.

With Ethernet or InfiniBand, the processing of the remote data could not start until the whole message was received and an ACK was returned to the sending node. It will be understood that with such processing, larger messages increase the delay in processing the data. In one example, in state 304, processing the message on the remote node can happen in under 55 nanoseconds in accordance with what is described, with the possibility of finishing the “work” on the message before Ethernet would even get the “message complete” to allow the system to start processing that message.

With link 320, in one example, sends are not blocked, seeing that sender broadcasts to all receiver nodes. It will be understood that the consumers could get blocked if multiple messages from multiple nodes are sent in quick succession and the producer has a delay in processing all the acknowledgements, with the potential that other nodes may also send update messages. In one example, the consumers receive a data update and put it directly in memory through a DMA mechanism. In such an implementation, the message time is effectively just the memory scheduling time, as the transmission and receipt over the optical communication link is much faster than the memory scheduling time.

Consider an example where system 310[1] sends the first cache line of data and at the same time schedules the transmit (TX) of the rest of the data. In one example, the sending of the first cache line is a command that indicates a total of 8 cache lines, with a Group ID 0, Packet ID 0 indicating that it is the first packet in the string, and sending offset offsets of 0x0000000000 to a receiving offset of 0x0000000000. The indications of the offsets here should not be understood to suggest that the two nodes have identical memory locations for their shared memory regions. Rather, every node could have the shared memory location (for the same Group) start at differing memory locations. The indicators and offsets would indicate that it is in Group 0, the first packet, and going to and from an offset of 0. The command causes the nonresident groups to update the first cache line and invalidate the rest of the lines in anticipation of the other lines being transferred.

The messaging would continue for all the new data or all updated data. The subsequent messages can indicate other offsets for the different data items sent. The command continues until all data is in place and the program has released the data lock to start processing. In one example, the cache Invalidation allows for the processing of messages before the whole data frame is received.

FIG. 3C illustrates state 306, in which system 310[1], system 310[2], system 310[3], and system 310[4] all have updated copies of shared memory 312, or each has an updated copy of the data in shared memory 312. In the snapshot of state 306, there is coherency of the shared memory data across all nodes.

FIG. 3D illustrates state 308, in which an update in one of the nodes to an item of shared memory 312 triggers an update message to the other nodes. For the example of state 308, system 310[2] is assumed to have executed an operation that resulted in a write to Item 4. As such, Item 4 in shared memory 312[2] is illustrated as being locked. System 310[2] has obtained a lock on Item 4 to allow it to update the shared memory.

When one of the nodes requires a lock for any process on that node it first sends an invalidate cache line to all the nodes. In one example, system 310[2] sends a message (MSG) on link 320 to the other nodes to indicate the update to shared memory 312[2] and trigger the other nodes to update their local copies of the shared memory. If none of the nodes are currently trying to invalidate the cache line, the message from system 310[2] causes the other nodes to mark Item 4 as invalid cache line(s). The invalidation of the item in shared memory causes any other node processes to stall out. In one example, a host bus adapter (HBA) includes hardware that ensures fair arbitration.

System 310[1], system 310[3], and system 310[4] all invalidate Item 4, as represented by the label “Item 4-X” in each of their local copies of the shared memory, and they send an ACK back to system 310[2]. In one example, the nodes invalidate a cache line of the local copy of the shared memory. In one example, the nodes invalidate multiple cache lines of the local copy of the shared memory.

After invalidation of the portion of the shared memory, in one example, the local process on system 310[2] that obtained the lock proceeds as a normal single system shared memory program. When it finishes with the lock, it then proceeds to release the lock, and schedules a data transmit of the cache line or updated shared memory space. The example provided shows a single item being locked and updated. An example system can treat up to 8192 bytes in a single send.

While not specifically illustrated, after receiving the ACK messages, and knowing all ACKs have been received, system 310[2] can commit the change to Item 4, and the other nodes will update their local copies of the shared memory with the data received from system 310[2]. In one example, all receiver nodes can update the data in their local copy of the shared memory as the data is processed from link 320. Thus, all copies of shared memory 312 will again be coherent and up to data.

The following represents an example of timing for a system. The timings for the following example are based on a producer/consumer model with a single producer and 31 consumers. The message is 256-bytes or 4 cache lines to be sent. The optical link provides 64 Gb/sec links between the devices. In the example, the time for the consumers to start processing the data is a certain number of nanoseconds plus one memory write cycle. Other timings are memory read cycles, DMA from the remote memory.

For the following example time, “MW” represents a memory write using DDR5-6400 cycle time of 16.25 nanoseconds, “CCL” represents a command cache line, and “DCL” represents a data cache line. The system starts the transaction, loading the command and data.

With a timing of 1 MW, the memory write occurs, loading the command.

With a timing of 10.13 nsec, the producer starts transmission of the CCL.

The transmission of the CCL overlaps with the start of receiving the CCL from the 31 consumers.

The producer loads the first DCL with the caching of the CCL load.

With a timing of 10.13 nsec, the producer starts transmit (TX) of the first DCL (the first load TX).

Overlapped with the first load TX is the start of the receive (RX) of the first DCL.

With a timing of 10.13 nsec for the response time, the consumers provide an ACK of the CCL plus the first data.

Simultaneously with the ACK, the 31 nodes are released to process the data.

A software start processing sees the 31 nodes start processing the first cache line.

With the message already sent, and each node able to process the data of the message, the start of the TX of the second DCL, the start of the RX of the second DCL, the start of the TX of the third DCL, the start of the RX of the third DCL, the start of the TX of the fourth DCL, and the start of the RX of the fourth DCL can all be hidden. The hidden timing refers to the fact that there is no system delay, and the nodes can simply process the data while commencing execution.

With a timing to transmit a full word, the consumers can provide an ACK of full data.

It can be observed that the timing before the nodes can start remotely working on the data is: 1 MW+10.13 nsec+1 MW for remote invalidation+10.13 nanoseconds+1 MW of the first cache line+10.13 nanoseconds. Thus, as a practical matter, a timing of approximately 2-6 MW cycles moves the data from the transmitting producer node to the consumer nodes.

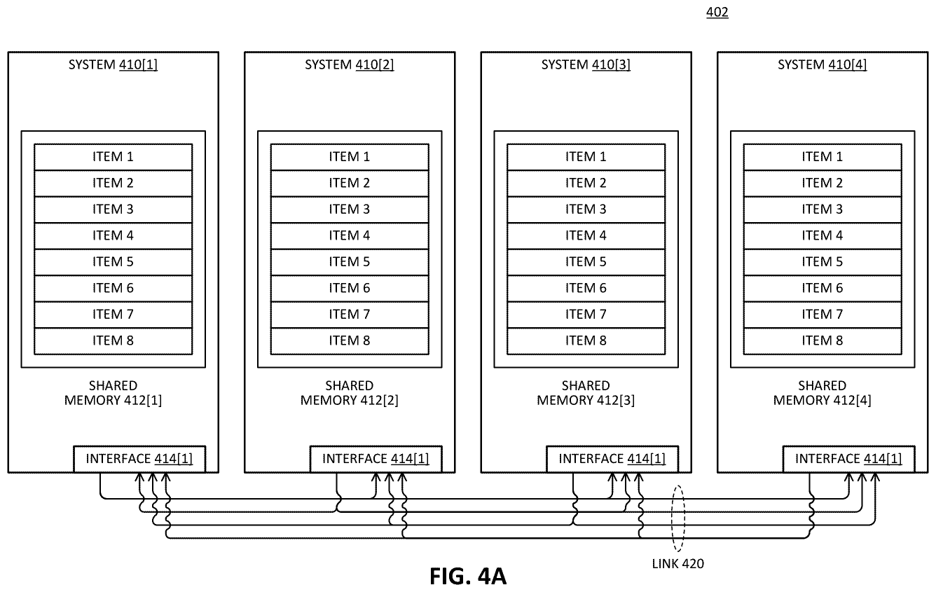

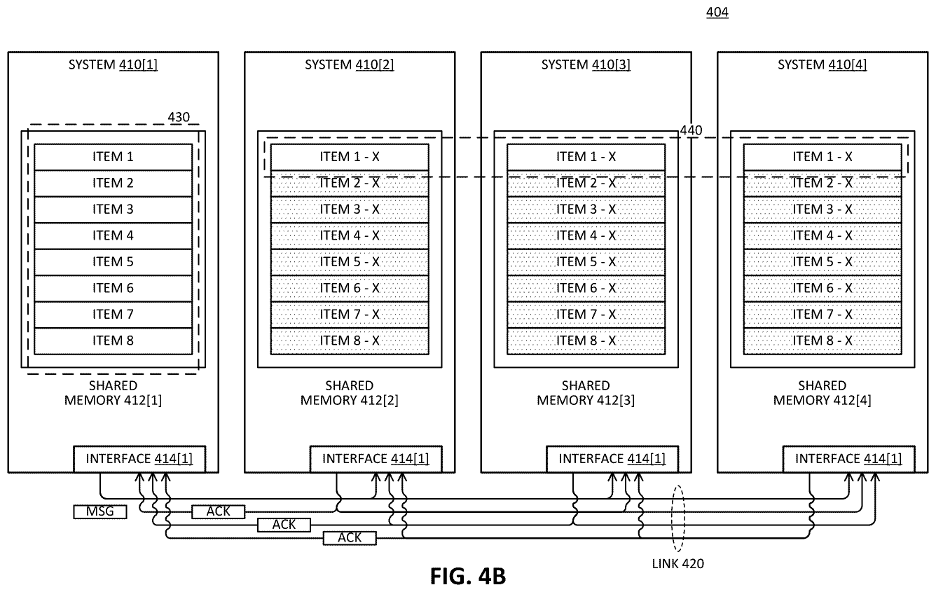

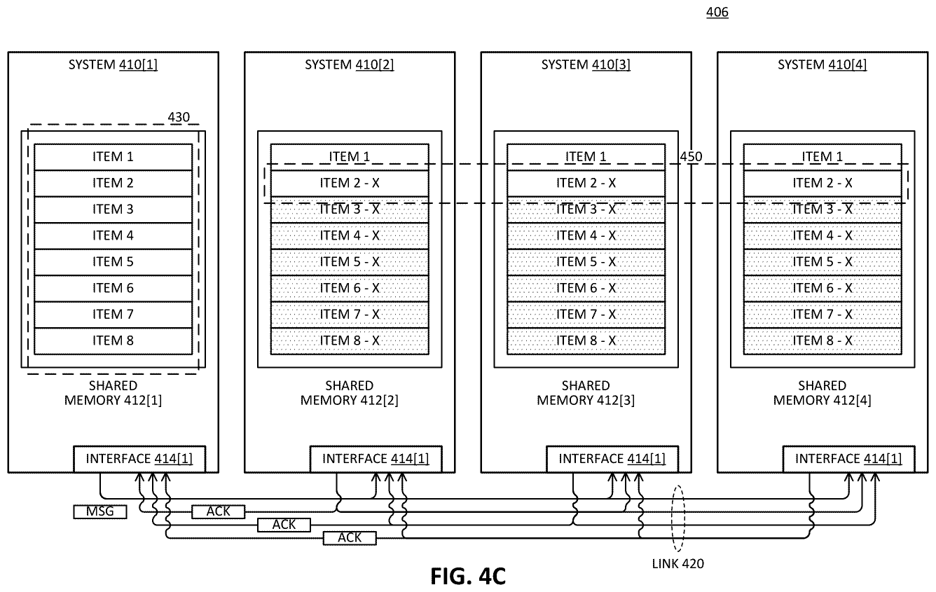

FIGS. 4A-4C are block diagrams of an example of a shared memory system response to a multi-cache line lock. The system of multiple nodes is a shared memory system with multiple computing/processing systems that share a memory space. The multiple nodes sharing a shared memory is a system in accordance with an example of system 100. Systems 410 are nodes in accordance with an example of node 210 of system 200.

The system is illustrated with four nodes, system 410[1], system 410[2], system 410[3], and system 410[4], collectively systems 410. Each system 410 can represent a server device, a processor node, a blade server, or some other node in a system that performs processing operations.

Systems 410 couple to link 420 through a communication interface, represented as interface 414[1] for system 410[1], interface 414[2] for system 410[2], interface 414[3] for system 410[3], and interface 414[4] for system 410[4]. Collectively, interface 414[1], interface 414[2], interface 414[3], . . . , interface 414[N] can be referred to as interfaces 414. Interfaces 414 can include interconnection hardware to couple to the physical communication link, and can include hardware to process data received over the link.

Systems 410 are coupled through link 420. Link 420 represents an optical communication link. As illustrated, link 420 includes a broadcast transmit from each system 410 to each other system 410. Thus, each system 410 includes a single transmit and multiple receive coupled to interfaces 414.

Each system includes a local copy of a shared memory. For purposes of the shared memory system, the shared memory can be referred to as shared memory 412. System 410[1] includes shared memory 412[1], which is the local copy of the shared memory in system 410[1]. System 410[2] includes shared memory 412[2], which is the local copy of the shared memory in system 410[2]. System 410[3] includes shared memory 412[3], which is the local copy of the shared memory in system 410[3]. System 410[4] includes shared memory 412[4], which is the local copy of the shared memory in system 410[4]. Shared memory 412 will have a start address and an end address for the various systems 410, which for simplicity are not specifically illustrated.

FIG. 4A illustrates state 402, in which system 410[1], system 410[2], system 410[3], and system 410[4] all have updated copies of shared memory 412. In the snapshot of state 402, there is coherency of the shared memory data across all nodes. While the example above was generic as to the type of message sent, the example here is specific to a multi-cache line message.

In the case of a multi-cache line (MCL) message the actual processing by the consumer nodes will be much less time than a normal message when the processing can be done in parallel with the receiving. The example provided shows the processing in parallel with the receiving. State 402 illustrates the initial MCL condition.

FIG. 4B illustrates state 404, in which system 410[1] sends a message (MSG) on link 420 to the other nodes to indicate the update to shared memory 412[1] and trigger the other nodes to update their local copies of the shared memory due to a multi-cache line change to shared memory 412. The other nodes send an ACK message back to system 410[1] in response to the message that indicates the data update.

In one example, system 410[1] either initializes Item 1, Item 2, . . . , Item 8 of shared memory 412[1], or updates each item of data, illustrated at 430. In one example, system 410[1] sends an MCL message (MSG) over link 420 to the other nodes. At 440, system 410[2], system 410[3], and system 410[4] invalidate Item 1 in shared memory 412[2], shared memory 412[3], and shared memory 412[4], respectively.

In one example, the message includes an indication of the size of the message, and the consumers invalidate Item 2, Item 3, . . . , Item 8 in preparation for additional data being received and processed. State 404 illustrates the invalidated Item 1 in each consumer shared memory, and the grayed-out Items 2-8 in these shared memories. Thus, in response to a lock of the cache line of Item 1, the consumers can invalidate the other cache lines.

In one example, as soon as system 410[2], system 410[3], and system 410[4] generate and schedule the ACK to send back to system 410[1], they can start processing the data. With the simplest form of the lock, system 410[1] is a producer and the other nodes are consumers who just read the data. With such a locking mechanism, as soon as the lock is cleared, all nodes (with the exception of the node that locked it) will start to process the data. They can start to read the cache lines and immediately stall out on the second line.

FIG. 4C illustrates state 406, in which system 410[1] sends a message (MSG) with the data for Item 2 to the other nodes. Once the second line arrives, and the consumer nodes have scheduled the ACK, the processors on the consumer nodes become unblocked and step to the next cache line. At 450, system 410[2], system 410[3], and system 410[4] invalidate Item 1 in shared memory 412[2], shared memory 412[3], and shared memory 412[4], respectively. The producer continues sending cache lines until it reaches the count and when the lack ACK returns from the last node, the producer can retire the command.

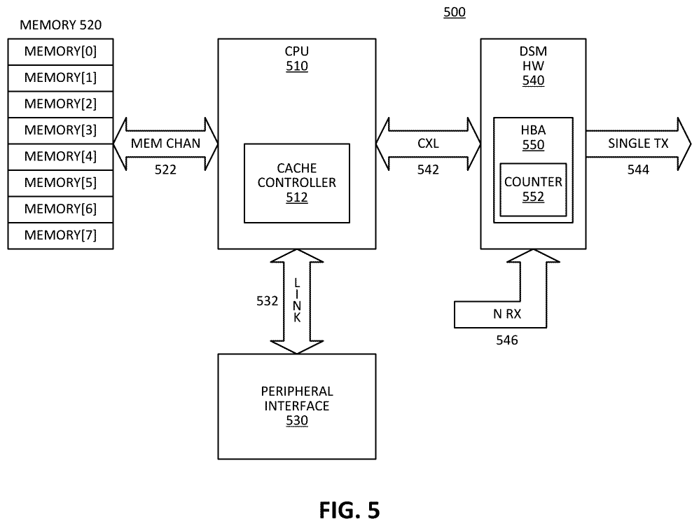

FIG. 5 is a block diagram of an example of a computer device of a shared memory architecture. System 500 represents components within a node of a system that has multiple devices that share a shared memory. System 500 can be a system in accordance with an example of system 100 or an example of system 200 and node 210.

System 500 includes central processing unit (CPU) 510, which represents processing resources for system 500. CPU 510 can be or include single core or multicore processors. In one example, CPU 510 executes the processes of system 500. CPU 510 can execute a program in accordance what is described above.

Memory 520 represents memory resources for system 500. Memory 520 is illustrated with multiple memory resources coupled to CPU 510 over memory channel (MEM CHAN) 522. Memory channel 522 represents a host system bus of a host device to locally connect memory 520 to CPU 510. Memory 520 is illustrated with eight resources, which can mean there are eight memory channels to CPU 510. System 500 can have more or fewer memory channels.

In one example, CPU 510 includes cache controller 512 to manage access to memory 520. While referred to as a cache controller, cache controller 512 can alternatively be referred to as a memory controller. The memory controller is the circuitry/component in CPU that manages access to memory 520. In a server environment with multiple devices coupled together, memory 520 will be less than the memory needs for the loads executed on system 500. Thus, memory 520 can operate to cache data locally for processes executed by CPU, with cache controller 512 managing caching and storage in memory 520 for the processes executed.

System 500 includes peripheral interface 530, referred to as interface 530 for simplicity. Interface 530 represents hardware in system 500 to enable interconnection of CPU 510 to peripheral devices, such as storage, user interface components, interconnects, and other peripherals. Interface 530 can be implemented by “chipset” components in a computer system. Interface 530 couples to CPU 510 over link 532. Link 532 can represent interconnection hardware between CPU 510 and interface 530.

In one example, system 500 includes distributed shared memory (DSM) hardware (HW) 540 to manage an interconnection to shared memory. More specifically, system 500 implements a local copy of shared memory in memory 520. DSM hardware 540 interconnects with other nodes in the multinode/multidevice system to send and receive memory updates to the shared memory.

The distributed, shared memory refers to the shared memory systems described, where a number of devices/nodes (N+1 nodes as illustrated in system 500) share a memory. The shared memory is distributed across a network system, where the various devices interconnect through an optical link.

In one example, DSM hardware 540 interconnects with CPU 510 over CXL 542, which represents a high-speed interconnect to the CPU. Alternatively, another high-speed communication link could connect CPU 510 to DSM hardware 540. In one example, DSM hardware 540 provides a single TX line 544, which can represent a single TX light pipe for the optical interconnect. In one example, DSM hardware 540 provides N RX lines 546, which can represent N light pipes for the optical interconnect. The combination of N RX 546 and single TX 544 is what is referred to as the optical link.

The single TX light pipe can be a broadcast optical connection, and the N RX light pipes can be receive lines from N other nodes. The systems above were described as having N nodes, and thus, the N RX lines here could be referred to as (N−1) RX lines, for N total nodes in the shared memory system, including system 500.

In one example, DSM hardware 540 includes hardware to monitor the optical link. For example, DSM hardware 540 can include encoder hardware, decoder hardware, serializer/deserializer (SERDES) hardware, and other hardware to enable transmission and receipt of message on the optical link. In one example, DSM hardware 540 performs bus snooping to look for addresses in the message. When it detects an address that applies to it and its shared memory, it can alert the receive hardware that there is a message to process.

The SERDES refers to a functional block, which can be implemented in hardware or in a combination of hardware and firmware. The SERDES serializes and deserializer data for the optical communication. In one example, the SERDES enables system 500 to transmit and receive at the same time.

In one example, DSM hardware 540 includes host bus adapter (HBA) 550. Typically, interface 530 includes an HBA to enable interconnecting to peripherals. HBA 550 can be similar to the HBA of interface 530. A host bus adapter enables the interconnection of peripherals to CPU 510, providing mechanisms to input data and to output data to devices outside of CPU 510 and memory 520, which can be considered the core of the computer system.

The HBA hardware can implement protocols that manage the interconnections. In one example, HBA 550 manages an optical/fiber protocol for an optical communication interface. For example, HBA 550 could implement a peripheral component interconnect express (PCI-e) link to fiber or a compute express link (CXL) to fiber link. HBA 550 can manage multiple interconnection links. In one example, HBA 550 can manage a DMA connection to cache controller 512 through CXL 542. The connections can enable system 500 to provide memory access for remote messages with a delay that is equivalent to, or comparable to, writing to local memory.

In one example, DSM hardware 540 manages communication with other nodes based on network commands that indicate a line count, a group identifier (ID), a packet ID, an address, and an offset. The messages indicate memory transactions at the various nodes. In one example, the line count is 16 bits, the group ID is 16 bits, the packet ID is 16 bits, the address is 40 bits, and the offset is 40 bits. The combination of bits can represent a message, which is the packet transmitted on the optical link. In one example, commands can be nested. Nesting sends would allow for greater than 64 endpoints/nodes to be used. The addressing can allow for 131 TB of directly addressable memory in a group.

In one example, HBA 550 is attached to a kernel process interface over CXL 542. The interface with the kernel can provide a very low latency connection, allowing for bus snooping between the system memory and HBA 550 of DSM hardware 540. It will be understood that another kernel interface beside CXL could be utilized. In one example, there is no snooping between different nodes in the multinode system. By preventing inter-node snooping, the system can perform more like a network and not be ruled by the complex issues that have plagued other shared memory and NUMA system implementation. The network architecture reduces the complexity of communication in the system.

In one example, HBA 550 passes through the transmission adding the workgroup and other information, which can eliminate the need to attach the address of the system transmitting. Consider a system in which all nodes are implemented as system 500. The consumer/receiver will know which node was the producer/sender for each packet based on the RX line, without needing information added to the packet. Additionally, in one example, DSM hardware 540 can contain all the needed information to enable the data transmission, allowing for fast operation without using system memory.

In one example, HBA 550 is responsible for accepting the incoming signals from the various ports and rejecting signals on ports that are not enabled. Consolidating the signals and attaching the proper DMA setup, HBA 550 can DMA the message into memory 520 and provide an ACK back to the sender to indicate the data was received. Such operation allows starting the processing of messages as soon as they are decoded or processed from the optical link. In one example, use of a 64/66-bit encoding enables on-the-fly processing of message, in that the 64/66-bit encoding has a rolling cyclic redundancy check (CRC) that verifies that an incoming 8 bytes are good. Once HBA 550 determines the data is good, it can initiate the process to acknowledge the message when all 64 bytes are received. In one example, HBA 550 can return the ACK before the DMA is accomplished, but would not retire the event until the DMA is completed.

In one example, at this point, if the DMA fails, the system would generate a system level error, such as a non-markable interrupt. The system level error can indicate a hardware failure resulting in a failure to perform DMA. Without access to DMA, the system could be unable to update the memory. The hardware failure can trigger marking the node as bad, triggering a recovery routine.

In one example, HBA 550 has access to cache controller 512 through the kernel process interface. In one example, access to the cache controller enables DSM hardware 540 to prevent blocking of messages over the optical link.

In one example, DSM hardware 540 performs signal processing at the interfaces to the optical link. In one example, at an optical sensor signal, if the sensor is supposed to be receiving, it can be turned into 64-bit wide data with parity (at least 2-bit detection and 1-bit correction).

After sensing the optical signal and performing parity, DSM hardware 540 can decode the signal to indicate which group it is in, based on detecting the group ID. The decoder is not specifically illustrated in DSM hardware 540. If the signal is in a group enabled for the sensor, the hardware can pass the signal on. The hardware can include electronics to allow for the settings related to enabling of the port and for the selection of the port number. In one example, all the receive modules will be identical. Thus, they can be plugged into a slot that is for Port 0 or Port 31, and then selected to enable the ports for the RX of the proper data with the proper port.

In one example, all modules are identical and interconnected with each other. Selecting the address for a module can include an address decode demultiplexer (ADD) signal fed into each module to set the address of each module. The number of bits in the ADD signal can be based on the number of nodes in the system (e.g., 5 bits to decode which of 32 optical modules has been selected). In one example, the hardware sends the ADD signal to the next level module, which is again the same for all the modules with the same ADD being used to determine the data that is loaded and decoded for the next step.

In one example, the processing at the optical interface includes a first level as a quick check to determine if the memory region (MR) is active for this port from this transmitter. Such a test can be a quick go/no-go test. If the memory region is active the hardware can pass it to the next level. In one example, passing the message to the next level includes using the 32 bits of address and checking a map which is updated from the host system.

At this point the hardware can transfer the signals to HBA 550. The signals are anticipated to be reduced in frequency as only the signals that need to be processed will be forwarded. In one example, the mapping performed by HBA 550 includes decoding the address of the packet.

In one example, HBA 550 includes counter 552, which represents an example of hardware to ensure fair arbitration. Counter 552 can be set to a value and count down to zero based on accesses to a cacheline. It will be understood that HBA 550 can include more than one counter to manage arbitration for different cachelines. In one example, consider that counter 552 is set to 3 or 4, allowing 3 or 4 local accesses to memory by CPU 510 before releasing a lock on a cacheline for external access by other nodes. If CPU 510 is performing operations and has a lock on a cache line of the shared memory, it could continue to lock out other nodes that want to access the cache line. HBA 550 can release the lock on a cache line after computation, and determine if there are local accesses waiting. If there are local accesses waiting and counter 552 has not expired, it can again lock the cache line for access. If there are no local accesses waiting, or if counter 552 has expired, it will release the lock to allow remote nodes to lock and access the cache line.

In one example, DSM hardware 540 decodes the message to determine the ability of the node to receive. If the node is not able to receive on this group, the node can ignore the message. If it is allowed to proceed, the hardware can determine a local offset of the memory region based on the offset in the message. The hardware can create the memory offset to insert the data into the system. The hardware can then decode the data and send it into the system memory with DAM. If there is not a current message length, the hardware can schedule the DMA and await the data in a subsequent message. In one example, the hardware also schedules an ACK to send.

If the message length is not zero, the hardware can add (+1 to the cacheline, which could be +64 to the address) to the offset and deduct (−1) from the message length and return to determining the offset from offset in the message and process further message data. If an error occurs in any of the processing, in one example, DSM hardware 540 immediately schedules a NACK and aborts receipt of the transmission.

In one example, DSM hardware 540 includes a cache. The use of caching in the processing of the messages can enable use of a wider range of group IDs.

In one example, cache controller 512 manages shared memory based on DMA requests from HBA 550. Cache controller 512 can use part or all of memory 520 as shared memory. In one example, when DSM hardware 540 performs a cache line invalidation in response to a message from a remote node, the hardware can trigger cache controller 512 to invalidate the cache line in response to receipt of the message packet. Cache controller 512 can subsequently write updates to the cache lines of memory 520 in response to messages processed by DSM hardware 540. The DSM hardware can thus work in connection with the CPU hardware to invalidate data and update data in response to packets received on the optical communication link.

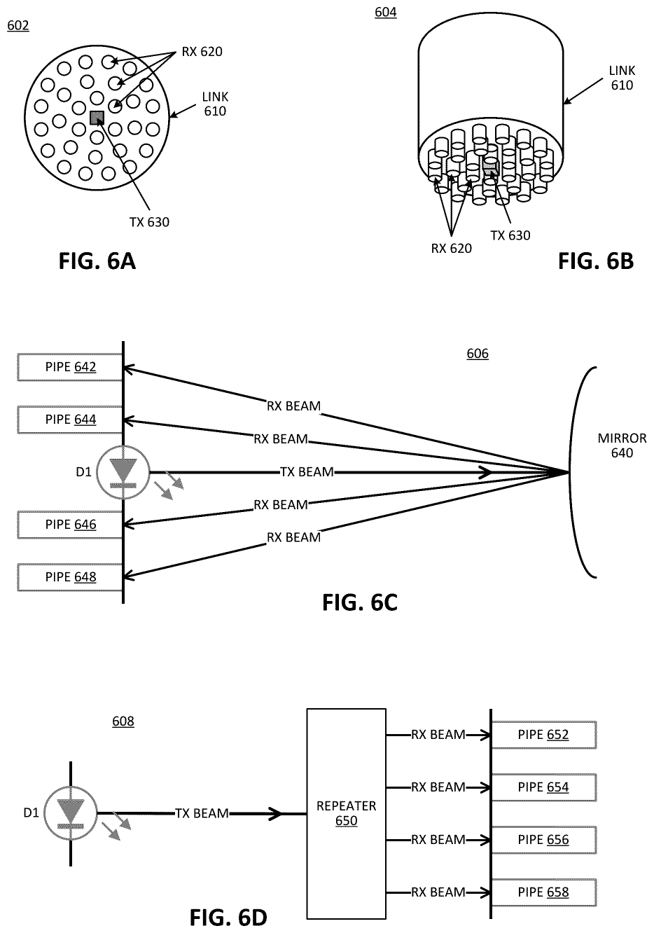

FIG. 6A-6B are diagrams of an example of an optical link for a shared memory system. View 602 represents a front view of an optical communication link (link 610) for a processor node of a system in accordance with an example of system 100 or system 200 or system 500. View 604 represents a front view of link 610.

The optical link illustrated has an optical fan out. The fan-out is accomplished by link 610 having a single transmit light pipe, represented by TX 630, and multiple receive light pipes, represented by RX 620. Link 610 is specifically illustrated for a network of 32 nodes, thus, having 32 optical paths. The 32 optical paths include the one TX path and 31 RX paths. The paths are referred to as “RX paths” because they carry a broadcast optical signal from TX 630 to the other nodes.

FIG. 6C is a block diagram of an example of an optical broadcast. Link 606 provides a simplified view of components that make up link 610. The optical broadcast is accomplished through the optical fan out. D1 represents an optical diode as TX 630, which is the optical transmitter.

The single optical transmission path is represented as the TX beam, which is sent to mirror 640, which spreads the single TX beam to all receiver pipes. Link 606 can represent an end or a cap for link 610, where D1 represents a powerful optical transmitter that transmits on a light pipe to a concave mirror at the end or cap of the link. In one example, mirror 640 spreads the single TX beam into 32 RX beams or into 64 RX beams. Mirror 640 can spread the TX signal into more or fewer RX beams. Thus, mirror 640 can be referred to as a spreading mirror that refracts light from the single transmit light pipe to the multiple receive light pipes, optically coupling the devices in the system. Pipe 642, pipe 644, pipe 646, and pipe 648 represent different light pipes to transmit to different nodes, where they will be one of multiple receive paths for each respective node.

FIG. 6D is a block diagram of another example of an optical broadcast. Link 608 provides a simplified view of an example of components that make up link 610. The optical broadcast is accomplished through the optical fan out through a repeater. D1 represents an optical diode as TX 630, which is the optical transmitter. It will be understood that the use of an optical repeater could introduce additional delay into the transmission as compared to the use of the mirror in link 606.

The single optical transmission path is represented as the TX beam, which is sent to repeater 650, which can represent an optical repeater array. Repeater 650 receives the TX beam and spreads it to all receiver pipes, which can include amplifying and reproducing the received signal. Repeater 650 can split the single TX beam into 32 RX beams or into 64 RX beams to the various receive lines. Repeater 650 can spread the TX signal into more or fewer RX beams. Repeater 650 can be referred to as an optical component that optically couples the devices in the system. Pipe 652, pipe 654, pipe 656, and pipe 658 represent different light pipes to transmit to different nodes, where they will be one of multiple receive paths for each respective node.

It will be understood that link 610 and link 606 provide a relatively inexpensive optical communication link for the distribution of signals. The transmission to the mirror allows simultaneous reception by the receivers. With the modular design, one light pipe could be serviced without disturbing the other data transmission circuits.

It will be understood that each of the nodes in the shared memory system would include a link such as link 610 and link 606. It will be understood that as designed, the transmit bandwidth is the limiting factor for communication in the system. When a producer is unable to produce any more, the system throughput becomes limited, because the receive bandwidth is the sum of all receive lines of the transmission, when the transmission is the speed of only one serializer. Thus, the throughput is limited by the producer's ability to produce.

In one example, there is the physical interconnection provided by link 610 and link 606, as well as the logical connection. The physical connection enables the transmission of the optical signal to other devices. The logical connection can refer to devices registering with each other as consumers, to receive their data updates. In one example, a node can be physically connected and not registered as a consumer of a shared memory for one or more processes. The devices can monitor the receive packets to determine if a message is from a producer for which the receiving node is registered as a consumer. If the node is not registered, it can ignore the optical communication.

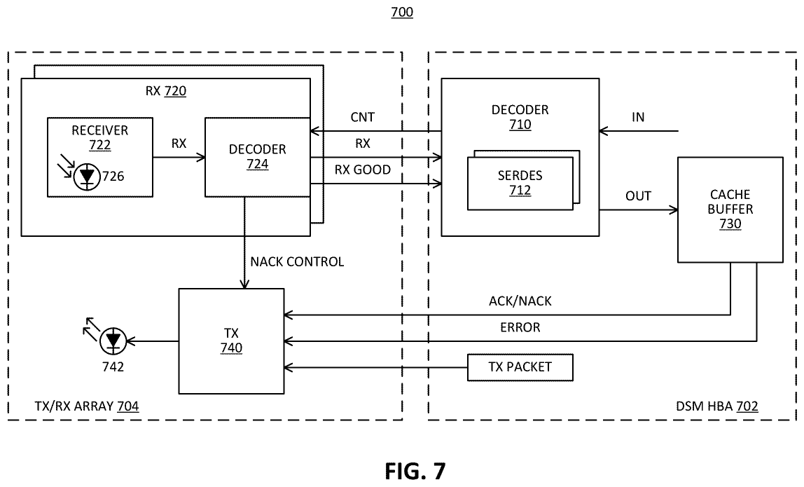

FIG. 7 is a block diagram of an example of a shared memory frontend interface. System 700 represents distributed shared memory hardware in accordance with an example of DSM hardware 540 of system 500. System 700 includes distributed shared memory (DSM) host bus adapter (HBA) 702 coupled to TX/RX array 704.

DSM HBA 702 includes decoder 710, which represents a decoder in the HBA to determine address and command information in response to received packets. In one example, DSM HBA 702 includes cache buffer 730 to cache outgoing messages. Cache buffer 730 can represent a buffer to enable scheduling of messages, both update messages and ACK/NACK messages.

TX/RX array 704 (referred to subsequently as array 704) includes the transmitter and the array of receivers. TX 740 represents the transmit hardware. TX 740 can prepare and drive a transmit signal through transmit optical diode 742.

RX 720 represents the receivers. In one example, RX 720 includes receiver hardware 722, which can include receive photodiode 726. Receiver 722 can provide an RX signal to decoder 724, which represents a decoder at the receiver array to snoop packets and determine when a message applies to the node. Decoder 724 can provide the RX signal to decoder 710 of DSM HBA 702. In one example, decoder 724 determines if the RX signal is good/valid, and can pass along an “RX good” signal to decoder 710 to indicate it should be processed.

In one example, if decoder 724 determines that the RX signal is not good, it can generate a NACK control signal to cause TX 740 to send out a NACK to the sender. It will be understood that ACK and NACK signals will be broadcast through TX 740 to other nodes. When an ACK/NACK is received from other nodes, decoder 724 can identify that signal, and system 700 can ignore NACK/ACK signals that do not apply to it as the sender.

In one example, decoder 710 can provide a count (CNT) signal to decoder 724 to indicate how many ACK signals have been received in response to a message. Thus, decoder 710 can manage the flow of messages when it is the producer.

In one example, decoder 710 receives data input (IN) to transmit. SERDES 712 represents a serializer/deserializer to convert received serial data signals into parallel data to write to memory, and convert input parallel signals into serial data signals to transmit over the optical link. In one example, decoder 710 includes multiple SERDES circuits, such as two SERDEs to enable simultaneous transmit and receive. After encoding the data, decoder 710 can provide transmit data (OUT) to cache buffer 730 to schedule the transmission. At the appropriate times, cache buffer 730 can forward ACK/NACK signals, error signals, and TX packets for transmission from TX 740.

In one example, SERDES 712 is a PCIe 6.0 SERDES, operated under the memory cycle time for DDR5-6400. With such a configuration, the NUMA effects will be almost unnoticeable because, other than the HBA setup time, there will be almost no latency other than the latency in SERDES 712. In one example, there are no components between the transmitter and the receiver that add delay other than two SERDES, which will overlap in time. The overlap in time can be when a first SERDES starts transmitting, the signal travels at optical speeds to the receivers, which can then respond with optical signals. Thus, the system may see approximately only the delay of one SERDES in the first order. A receiving SERDES can translate the message and DMA it into memory, where it becomes instantly available for use by the receiving node.

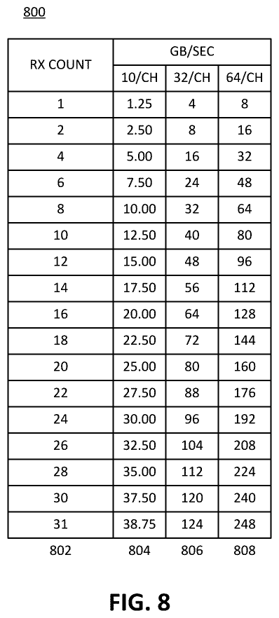

FIG. 8 is a table representation of additive bandwidth. Table 800 illustrates an example of bandwidth per receiver count. The table illustrates how the bandwidth is additive in a system in accordance with an example of system 100, system 200, system 500, system 700.

Table 800 reflects the raw bandwidth for the interface. In all receive count examples, it can be assumed that one transmitter is used per link, and the receive count indicates how many receive lines are present per link. It can be observed that the receive bandwidth increases with the number of endpoints.

As described above, since each receiver can also broadcast transmit at the same time, the optical link can have multiple nodes simultaneously acting as producers and transmitting at the same time. In one example, the overall RX bandwidth of any node is limited by the width of the CXL interface for that node.

For table 800, consider a x8 CXL link having a receive bandwidth of 248 gigabytes per second (GB/sec). With eight channels, a max receive bandwidth of 8 times 248 GB/sec provides a total of 1.9 terabytes per second (TB/sec).

Column 802 of table 800 illustrates the RX count. Column 804 represents a link with 10 GB/sec per x8 channel (CH). Column 806 represents a link with 32 GB/sec per x8 channel (CH). Column 808 represents a link with 64 GB/sec per x8 channel (CH). Column 804 illustrates the 10 GB/sec when the RX count is 8 (e.g., the x8), column 806 illustrates the 32 GB/sec when the RX count is 8, and column 8 illustrates the 64 GB/sec when the RX count is 8.

The first row illustrates 1.25 GB/sec for a single receiver for column 804, 4 GB/sec for a single receiver for column 806, and 8 GB/sec for a single receiver for column 808. All other values can be computed based on multiplying the base rate of a single receiver times the number of receivers, showing the additive nature of the link. Namely, the bandwidth increases correspondingly with the increase in RX count.

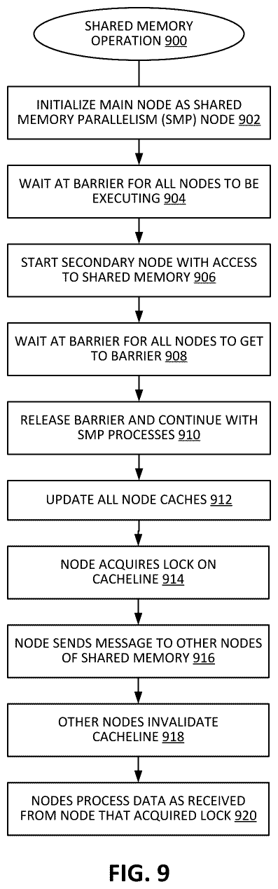

FIG. 9 is a flow diagram of an example of a process for a shared memory system. Process 900 represents shared memory operation in accordance with an example of the systems described herein.

In one example, the system initializes a main node as a shared memory parallelism (SMP) node, at 902. The nodes can wait at a data barrier for all nodes to be executing, at 904. The system can start secondary nodes with access to the shared memory, at 906. In one example, the system can wait at a data barrier for all nodes to arrive at the barrier, at 908.

In one example, the main node releases the barrier and continues with the execution of SMP process operations, at 910. The main node can send out one or more messages to the secondary nodes to update all node caches, at 912.

In one example, the producer node acquires a lock on a cache line, at 914. The node acquiring the lock can send a message to the other nodes of the shared memory, at 916. The message can indicate an update to one or more cache lines of the share memory. In response to the message, the other nodes invalidate the cache line or cache lines locked by the node, at 918. The consumer nodes can process data updates as received over the optical link from the node that acquired the lock, at 920.

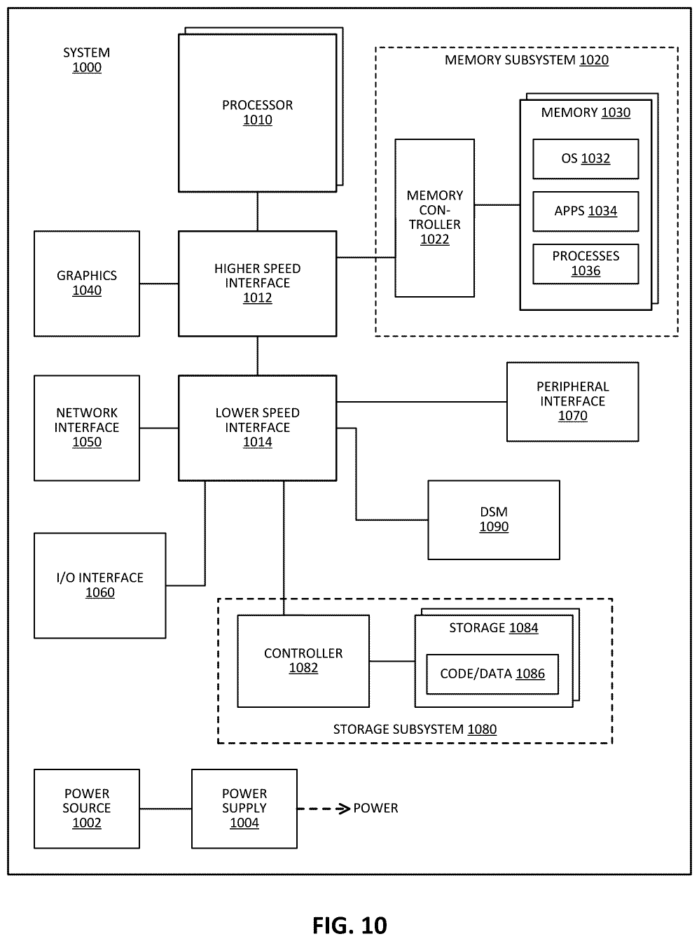

FIG. 10 is a block diagram of an example of a computing system in which a shared memory interface can be implemented. System 1000 represents a computing device in accordance with any example herein, and can be a laptop computer, a desktop computer, a tablet computer, a server, a gaming or entertainment control system, embedded computing device, or other electronic device.

System 1000 includes distributed shared memory (DSM) 1090, which represents DSM hardware in accordance with any example herein. The DSM hardware interfaces with an optical link that interconnects nodes that share the shared memory. The components and operations of the DSM hardware can be in accordance with any example herein.

System 1000 includes processor 1010 can include any type of microprocessor, central processing unit (CPU), graphics processing unit (GPU), processing core, or other processing hardware, or a combination, to provide processing or execution of instructions for system 1000. Processor 1010 can be a host processor device. Processor 1010 controls the overall operation of system 1000, and can be or include, one or more programmable general-purpose or special-purpose microprocessors, digital signal processors (DSPs), programmable controllers, application specific integrated circuits (ASICs), programmable logic devices (PLDs), or a combination of such devices.

In one example, system 1000 includes interface 1012 coupled to processor 1010, which can represent a higher speed interface or a high throughput interface for system components that need higher bandwidth connections, such as memory subsystem 1020 or graphics interface components 1040. Interface 1012 represents an interface circuit, which can be a standalone component or integrated onto a processor die. Interface 1012 can be integrated as a circuit onto the processor die or integrated as a component on a system on a chip. Where present, graphics interface 1040 interfaces to graphics components for providing a visual display to a user of system 1000. Graphics interface 1040 can be a standalone component or integrated onto the processor die or system on a chip. In one example, graphics interface 1040 can drive a high definition (HD) display or ultra high definition (UHD) display that provides an output to a user. In one example, the display can include a touchscreen display. In one example, graphics interface 1040 generates a display based on data stored in memory 1030 or based on operations executed by processor 1010 or both.

Memory subsystem 1020 represents the main memory of system 1000, and provides storage for code to be executed by processor 1010, or data values to be used in executing a routine. Memory subsystem 1020 can include one or more memory devices 1030 such as read-only memory (ROM), flash memory, one or more varieties of random-access memory (RAM) such as DRAM, 3DXP (three-dimensional crosspoint), or other memory devices, or a combination of such devices. Memory 1030 stores and hosts, among other things, operating system (OS) 1032 to provide a software platform for execution of instructions in system 1000. Additionally, applications 1034 can execute on the software platform of OS 1032 from memory 1030. Applications 1034 represent programs that have their own operational logic to perform execution of one or more functions. Processes 1036 represent agents or routines that provide auxiliary functions to OS 1032 or one or more applications 1034 or a combination. OS 1032, applications 1034, and processes 1036 provide software logic to provide functions for system 1000. In one example, memory subsystem 1020 includes memory controller 1022, which is a memory controller to generate and issue commands to memory 1030. It will be understood that memory controller 1022 could be a physical part of processor 1010 or a physical part of interface 1012. For example, memory controller 1022 can be an integrated memory controller, integrated onto a circuit with processor 1010, such as integrated onto the processor die or a system on a chip.

While not specifically illustrated, it will be understood that system 1000 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a HyperTransport or industry standard architecture (ISA) bus, a small computer system interface (SCSI) bus, a universal serial bus (USB), or other bus, or a combination.

In one example, system 1000 includes interface 1014, which can be coupled to interface 1012. Interface 1014 can be a lower speed interface than interface 1012. In one example, interface 1014 represents an interface circuit, which can include standalone components and integrated circuitry. In one example, multiple user interface components or peripheral components, or both, couple to interface 1014. Network interface 1050 provides system 1000 the ability to communicate with remote devices (e.g., servers or other computing devices) over one or more networks. Network interface 1050 can include an Ethernet adapter, wireless interconnection components, cellular network interconnection components, USB (universal serial bus), or other wired or wireless standards-based or proprietary interfaces. Network interface 1050 can exchange data with a remote device, which can include sending data stored in memory or receiving data to be stored in memory.

In one example, system 1000 includes one or more input/output (I/O) interface(s) 1060. I/O interface 1060 can include one or more interface components through which a user interacts with system 1000 (e.g., audio, alphanumeric, tactile/touch, or other interfacing). Peripheral interface 1070 can include any hardware interface not specifically mentioned above. Peripherals refer generally to devices that connect dependently to system 1000. A dependent connection is one where system 1000 provides the software platform or hardware platform or both on which operation executes, and with which a user interacts.

In one example, system 1000 includes storage subsystem 1080 to store data in a nonvolatile manner. In one example, in certain system implementations, at least certain components of storage 1080 can overlap with components of memory subsystem 1020. Storage subsystem 1080 includes storage device(s) 1084, which can be or include any conventional medium for storing large amounts of data in a nonvolatile manner, such as one or more magnetic, solid state, 3DXP, or optical based disks, or a combination. Storage 1084 holds code or instructions and data 1086 in a persistent state (i.e., the value is retained despite interruption of power to system 1000). Storage 1084 can be generically considered to be a “memory,” although memory 1030 is typically the executing or operating memory to provide instructions to processor 1010. Whereas storage 1084 is nonvolatile, memory 1030 can include volatile memory (i.e., the value or state of the data is indeterminate if power is interrupted to system 1000). In one example, storage subsystem 1080 includes controller 1082 to interface with storage 1084. In one example controller 1082 is a physical part of interface 1014 or processor 1010, or can include circuits or logic in both processor 1010 and interface 1014.

Power source 1002 provides power to the components of system 1000. More specifically, power source 1002 typically interfaces to one or multiple power supplies 1004 in system 1000 to provide power to the components of system 1000. In one example, power supply 1004 includes an AC to DC (alternating current to direct current) adapter to plug into a wall outlet. Such AC power can be renewable energy (e.g., solar power) power source 1002. In one example, power source 1002 includes a DC power source, such as an external AC to DC converter. In one example, power source 1002 or power supply 1004 includes wireless charging hardware to charge via proximity to a charging field. In one example, power source 1002 can include an internal battery or fuel cell source.

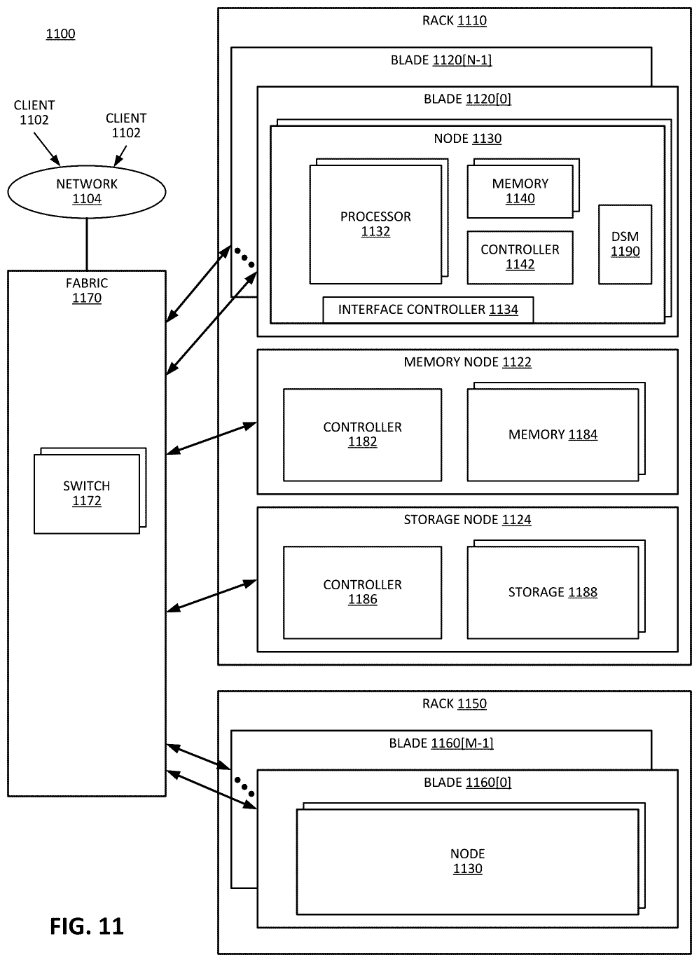

FIG. 11 is a block diagram of an example of a multi-node network in which a shared memory system can be implemented. System 1100 represents a network of nodes that can apply adaptive ECC. In one example, system 1100 represents a data center. In one example, system 1100 represents a server farm. In one example, system 1100 represents a data cloud or a processing cloud.

System 1100 represents a system with storage in accordance with an example of system 100 or system 200. In one example, system 1100 includes node 1130, which can be a node that shares a shared memory in accordance with any example herein. In one example, node includes distributed shared memory (DSM) 1190, which represents DSM hardware in accordance with any example herein. The DSM hardware interfaces with an optical link that interconnects nodes that share the shared memory. The components and operations of the DSM hardware can be in accordance with any example herein.

One or more clients 1102 make requests over network 1104 to system 1100. Network 1104 represents one or more local networks, or wide area networks, or a combination. Clients 1102 can be human or machine clients, which generate requests for the execution of operations by system 1100. System 1100 executes applications or data computation tasks requested by clients 1102.

In one example, system 1100 includes one or more racks, which represent structural and interconnect resources to house and interconnect multiple computation nodes. In one example, rack 1110 includes multiple nodes 1130. In one example, rack 1110 hosts multiple blade components, blade 1120[0], . . . , blade 1120[N−1], collectively blades 1120. Hosting refers to providing power, structural or mechanical support, and interconnection. Blades 1120 can refer to computing resources on printed circuit boards (PCBs), where a PCB houses the hardware components for one or more nodes 1130. In one example, blades 1120 do not include a chassis or housing or other “box” other than that provided by rack 1110. In one example, blades 1120 include housing with exposed connector to connect into rack 1110. In one example, system 1100 does not include rack 1110, and each blade 1120 includes a chassis or housing that can stack or otherwise reside in close proximity to other blades and allow interconnection of nodes 1130.

System 1100 includes fabric 1170, which represents one or more interconnectors for nodes 1130. In one example, fabric 1170 includes multiple switches 1172 or routers or other hardware to route signals among nodes 1130. Additionally, fabric 1170 can couple system 1100 to network 1104 for access by clients 1102. In addition to routing equipment, fabric 1170 can be considered to include the cables or ports or other hardware equipment to couple nodes 1130 together. In one example, fabric 1170 has one or more associated protocols to manage the routing of signals through system 1100. In one example, the protocol or protocols is at least partly dependent on the hardware equipment used in system 1100.

As illustrated, rack 1110 includes N blades 1120. In one example, in addition to rack 1110, system 1100 includes rack 1150. As illustrated, rack 1150 includes M blade components, blade 1160[0], . . . , blade 1160[M−1], collectively blades 1160. M is not necessarily the same as N; thus, it will be understood that various different hardware equipment components could be used, and coupled together into system 1100 over fabric 1170. Blades 1160 can be the same or similar to blades 1120. Nodes 1130 can be any type of node and are not necessarily all the same type of node. System 1100 is not limited to being homogenous, nor is it limited to not being homogenous.

The nodes in system 1100 can include compute nodes, memory nodes, storage nodes, accelerator nodes, or other nodes. Rack 1110 is represented with memory node 1122 and storage node 1124, which represent shared system memory resources, and shared persistent storage, respectively. One or more nodes of rack 1150 can be a memory node or a storage node.

Nodes 1130 represent examples of compute nodes. For simplicity, only the compute node in blade 1120[0] is illustrated in detail. However, other nodes in system 1100 can be the same or similar. At least some nodes 1130 are computation nodes, with processor (proc) 1132 and memory 1140. A computation node refers to a node with processing resources (e.g., one or more processors) that executes an operating system and can receive and process one or more tasks. In one example, at least some nodes 1130 are server nodes with a server as processing resources represented by processor 1132 and memory 1140.

Memory node 1122 represents an example of a memory node, with system memory external to the compute nodes. Memory nodes can include controller 1182, which represents a processor on the node to manage access to the memory. The memory nodes include memory 1184 as memory resources to be shared among multiple compute nodes.

Storage node 1124 represents an example of a storage server, which refers to a node with more storage resources than a computation node, and rather than having processors for the execution of tasks, a storage server includes processing resources to manage access to the storage nodes within the storage server. Storage nodes can include controller 1186 to manage access to the storage 1188 of the storage node.

In one example, node 1130 includes interface controller 1134, which represents logic to control access by node 1130 to fabric 1170. The logic can include hardware resources to interconnect to the physical interconnection hardware. The logic can include software or firmware logic to manage the interconnection. In one example, interface controller 1134 is or includes a host fabric interface, which can be a fabric interface in accordance with any example described herein. The interface controllers for memory node 1122 and storage node 1124 are not explicitly shown.

Processor 1132 can include one or more separate processors. Each separate processor can include a single processing unit, a multicore processing unit, or a combination. The processing unit can be a primary processor such as a CPU (central processing unit), a peripheral processor such as a GPU (graphics processing unit), or a combination. Memory 1140 can be or include memory devices represented by memory 1140 and a memory controller represented by controller 1142.

In general with respect to the descriptions herein, a host device of a multidevice system includes: a network interface to an optical communication link to other devices of the multidevice system, wherein the host device is a producer to transmit to the other device on the optical communication link and a consumer to receive from the other devices on the optical communication link; a decoder to receive a packet when the host device is a consumer, wherein the network interface is to send an acknowledgement (ACK) or negative acknowledgement (NACK) in response to the packet; and hardware to invalidate a cache line of a local copy of a shared memory in response to receipt of the packet and write an updated copy of the cache line into the local copy of the shared memory as the updated copy of the cache line is processed from the optical communication link.

In one example of the host device, the optical communication link includes a single transmit light pipe and multiple receive light pipes, one receive light pipe for each of the other devices. In accordance with any preceding example of the host device, the host device is to register as a consumer of the other devices, and the other devices are to register as consumers of the host device. In accordance with any preceding example of the host device, the hardware comprises: an address decoder to snoop packets for address information, and trigger invalidation of the cache line in response to the address information. In accordance with any preceding example of the host device, the hardware comprises: a cache controller for the local copy of the shared memory, the cache controller to invalidate the cache line in response to receipt of the packet, and to write the updated copy of the cache line into the local copy of the shared memory. In accordance with any preceding example of the host device, the packet comprises a first packet of a multiple cache line message indicating multiple cache lines to update, and wherein the hardware is to invalidate the multiple cache lines in response to the first packet, and write updated copies of the multiple cache lines as the multiple cache lines are processed from the optical communication link.

In general with respect to the descriptions herein, a network system includes: an optical communication link; and N server devices connected to each other over the optical communication link, each server device including: a local copy of a shared memory; and an network interface to the optical communication link, including a single transmit light pipe and (N−1) receive light pipes, the single transmit light pipe to send a packet to N−1 other server devices as a producer in response to locking a cache line of data in the local copy of the shared memory, and the (N−1) receive light pipes to receive messages from the N−1 other server devices as a consumer of shared messages from the N−1 other server devices.

In one example of the network system, the network interface to the optical communication link comprises a transmitter optically coupled to the single transmit light pipe and an optical receiver optically coupled to each of the N−1 receive light pipes. In accordance with any preceding example of the network system, wherein the N server devices are to register with each other as consumers of shared messages from the N−1 other server devices. In accordance with any preceding example of the network system, the packet comprises a first packet of a multiple cache line message indicating multiple cache lines to update, and wherein the consumers are to invalidate the multiple cache lines in response to the first packet, and write updated copies of the multiple cache lines as the multiple cache lines are processed from the optical communication link. In accordance with any preceding example of the network system, the network interface comprises: a decoder to receive a packet on one of the receive light pipes, wherein the network interface is to send an acknowledgement (ACK) or negative acknowledgement (NACK) in response to the packet on the transmit light pipe. In accordance with any preceding example of the network system, the N server devices comprise: hardware to invalidate a cache line of the local copy of the shared memory in response to receipt of the packet and write an updated copy of the cache line into the local copy of the shared memory as the updated copy of the cache line is processed from the optical communication link. In accordance with any preceding example of the network system, the hardware comprises: an address decoder to snoop packets for address information, and trigger invalidation of the cache line in response to the address information. In accordance with any preceding example of the network system, the hardware comprises: a cache controller for the local copy of the shared memory, the cache controller to invalidate the cache line in response to receipt of the packet, and to write the updated copy of the cache line into the local copy of the shared memory. In accordance with any preceding example of the network system, the N server devices comprise blade servers. In accordance with any preceding example of the network system, one of the N server devices is designated as a primary node and the other server devices are secondary nodes, wherein the primary node first initializes its local copy of the shared memory, and the secondary nodes subsequently initialize their local copies of the shared memory based on messages from the primary node. In accordance with any preceding example of the network system, in response to any of the N server devices obtaining a data lock on a cache line of the shared memory, the other server devices will stall during execution at the cache line with the data lock until the cache line is updated and the data lock is released.

In general with respect to the descriptions herein, a method for memory sharing includes: receiving a packet over an optical communication link in response to a change to a shared memory by one of multiple other nodes that share the shared memory; sending an acknowledgement (ACK) or negative acknowledgement (NACK) in response to the packet; and invalidating a cache line of a local copy of the shared memory in response to receipt of the packet; and writing an updated copy of the cache line into the local copy of the shared memory as the updated copy of the cache line is processed from the optical communication link.

In one example of the method, the packet comprises a first packet of a multiple cache line message, and wherein invalidating the cache line comprises invalidating multiple cache lines in response to the first packet, and writing updated copies of the multiple cache lines as the multiple cache lines are processed from the optical communication link. In accordance with any preceding example of the method, wherein the N server devices are to register with each other as consumers of shared messages from the N−1 other server devices. In accordance with any preceding example of the method, the packet comprises a first packet of a multiple cache line message indicating multiple cache lines to update, and wherein the consumers are to invalidate the multiple cache lines in response to the first packet, and write updated copies of the multiple cache lines as the multiple cache lines are processed from the optical communication link. In accordance with any preceding example of the method, the network interface comprises: a decoder to receive a packet on one of the receive light pipes, wherein the network interface is to send an acknowledgement (ACK) or negative acknowledgement (NACK) in response to the packet on the transmit light pipe. In accordance with any preceding example of the method, the N server devices comprise: hardware to invalidate a cache line of the local copy of the shared memory in response to receipt of the packet and write an updated copy of the cache line into the local copy of the shared memory as the updated copy of the cache line is processed from the optical communication link. In accordance with any preceding example of the method, the hardware comprises: an address decoder to snoop packets for address information, and trigger invalidation of the cache line in response to the address information. In accordance with any preceding example of the method, the hardware comprises: a cache controller for the local copy of the shared memory, the cache controller to invalidate the cache line in response to receipt of the packet, and to write the updated copy of the cache line into the local copy of the shared memory. In accordance with any preceding example of the method, the N server devices comprise blade servers. In accordance with any preceding example of the method, one of the N server devices is designated as a primary node and the other server devices are secondary nodes, wherein the primary node first initializes its local copy of the shared memory, and the secondary nodes subsequently initialize their local copies of the shared memory based on messages from the primary node. In accordance with any preceding example of the method, in response to any of the N server devices obtaining a data lock on a cache line of the shared memory, the other server devices will stall during execution at the cache line with the data lock until the cache line is updated and the data lock is released.

Flow diagrams as illustrated herein provide examples of sequences of various process actions. The flow diagrams can indicate operations to be executed by a software or firmware routine, as well as physical operations. A flow diagram can illustrate an example of the implementation of states of a finite state machine (FSM), which can be implemented in hardware and/or software. Although shown in a particular sequence or order, unless otherwise specified, the order of the actions can be modified. Thus, the illustrated diagrams should be understood only as examples, and the process can be performed in a different order, and some actions can be performed in parallel. Additionally, one or more actions can be omitted; thus, not all implementations will perform all actions.

To the extent various operations or functions are described herein, they can be described or defined as software code, instructions, configuration, and/or data. The content can be directly executable (“object” or “executable” form), source code, or difference code (“delta” or “patch” code). The software content of what is described herein can be provided via an article of manufacture with the content stored thereon, or via a method of operating a communication interface to send data via the communication interface. A machine readable storage medium can cause a machine to perform the functions or operations described, and includes any mechanism that stores information in a form accessible by a machine (e.g., computing device, electronic system, etc.), such as recordable/non-recordable media (e.g., read only memory (ROM), random access memory (RAM), magnetic disk storage media, optical storage media, flash memory devices, etc.). A communication interface includes any mechanism that interfaces to any of a hardwired, wireless, optical, etc., medium to communicate to another device, such as a memory bus interface, a processor bus interface, an Internet connection, a disk controller, etc. The communication interface can be configured by providing configuration parameters and/or sending signals to prepare the communication interface to provide a data signal describing the software content. The communication interface can be accessed via one or more commands or signals sent to the communication interface.

Various components described herein can be a means for performing the operations or functions described. Each component described herein includes software, hardware, or a combination of these. The components can be implemented as software modules, hardware modules, special-purpose hardware (e.g., application specific hardware, application specific integrated circuits (ASICs), digital signal processors (DSPs), etc.), embedded controllers, hardwired circuitry, etc.

Besides what is described herein, various modifications can be made to what is disclosed and implementations of the invention without departing from their scope. Therefore, the illustrations and examples herein should be construed in an illustrative, and not a restrictive sense. The scope of the invention should be measured solely by reference to the claims that follow.

What is claimed is:

1. A host device of a multidevice system, comprising:
a network interface to an optical communication link to other devices of the multidevice system, wherein the host device is a producer to transmit to the other device on the optical communication link and a consumer to receive from the other devices on the optical communication link;
a decoder to receive a packet when the host device is a consumer, wherein the network interface is to send an acknowledgement (ACK) or negative acknowledgement (NACK) in response to the packet; and
hardware to invalidate a cache line of a local copy of a shared memory in response to receipt of the packet and write an updated copy of the cache line into the local copy of the shared memory as the updated copy of the cache line is processed from the optical communication link.

2. The host device of claim 1, wherein the optical communication link includes a single transmit light pipe and multiple receive light pipes, one receive light pipe for each of the other devices.

3. The host device of claim 1, wherein the host device is to register as a consumer of the other devices, and the other devices are to register as consumers of the host device.

4. The host device of claim 1, wherein the hardware comprises:
an address decoder to snoop packets for address information, and trigger invalidation of the cache line in response to the address information.

5. The host device of claim 1, wherein the hardware comprises:
a cache controller for the local copy of the shared memory, the cache controller to invalidate the cache line in response to receipt of the packet, and to write the updated copy of the cache line into the local copy of the shared memory.

6. The host device of claim 1, wherein the packet comprises a first packet of a multiple cache line message indicating multiple cache lines to update, and wherein the hardware is to invalidate the multiple cache lines in response to the first packet, and write updated copies of the multiple cache lines as the multiple cache lines are processed from the optical communication link.

7. A network system, comprising:
an optical communication link; and
N server devices connected to each other over the optical communication link, each server device including:
a local copy of a shared memory; and
an network interface to the optical communication link, including a single transmit light pipe and (N−1) receive light pipes, the single transmit light pipe to send a packet to N−1 other server devices as a producer in response to locking a cache line of data in the local copy of the shared memory, and the (N−1) receive light pipes to receive messages from the N−1 other server devices as a consumer of shared messages from the N−1 other server devices.

8. The network system of claim 7, wherein the network interface to the optical communication link comprises a transmitter optically coupled to the single transmit light pipe and an optical receiver optically coupled to each of the N−1 receive light pipes.

9. The network system of claim 7, wherein the N server devices are to register with each other as consumers of shared messages from the N−1 other server devices.

10. The network system of claim 7, wherein the packet comprises a first packet of a multiple cache line message indicating multiple cache lines to update, and wherein the consumers are to invalidate the multiple cache lines in response to the first packet, and write updated copies of the multiple cache lines as the multiple cache lines are processed from the optical communication link.

11. The network system of claim 7, wherein the network interface comprises:
a decoder to receive a packet on one of the receive light pipes, wherein the network interface is to send an acknowledgement (ACK) or negative acknowledgement (NACK) in response to the packet on the transmit light pipe.

12. The network system of claim 11, wherein the N server devices comprise:
hardware to invalidate a cache line of the local copy of the shared memory in response to receipt of the packet and write an updated copy of the cache line into the local copy of the shared memory as the updated copy of the cache line is processed from the optical communication link.

13. The network system of claim 12, wherein the hardware comprises:
an address decoder to snoop packets for address information, and trigger invalidation of the cache line in response to the address information.

14. The network system of claim 12, wherein the hardware comprises:
a cache controller for the local copy of the shared memory, the cache controller to invalidate the cache line in response to receipt of the packet, and to write the updated copy of the cache line into the local copy of the shared memory.

15. The network system of claim 7, wherein the N server devices comprise blade servers.

16. The network system of claim 7, wherein one of the N server devices is designated as a primary node and the other server devices are secondary nodes, wherein the primary node first initializes its local copy of the shared memory, and the secondary nodes subsequently initialize their local copies of the shared memory based on messages from the primary node.

17. The network system of claim 7, wherein, in response to any of the N server devices obtaining a data lock on a cache line of the shared memory, the other server devices will stall during execution at the cache line with the data lock until the cache line is updated and the data lock is released.

18. A method for memory sharing, comprising:
receiving a packet over an optical communication link in response to a change to a shared memory by one of multiple other nodes that share the shared memory;
sending an acknowledgement (ACK) or negative acknowledgement (NACK) in response to the packet; and
invalidating a cache line of a local copy of the shared memory in response to receipt of the packet; and
writing an updated copy of the cache line into the local copy of the shared memory as the updated copy of the cache line is processed from the optical communication link.

19. The method of claim 18, wherein the optical communication link includes a single transmit light pipe and multiple receive light pipes, one receive light pipe for each of the multiple other nodes.

20. The method of claim 18, wherein the packet comprises a first packet of a multiple cache line message, and wherein invalidating the cache line comprises invalidating multiple cache lines in response to the first packet, and writing updated copies of the multiple cache lines as the multiple cache lines are processed from the optical communication link.
